(19) United States
(12) Patent Application Publication
(10) Pub. No.: US 2023/0281871 A1
(43) Pub. Date: Sep. 7, 2023

(54) FUSION OF IMAGING DATA AND LIDAR DATA FOR IMPROVED OBJECT RECOGNITION

(71) Applicant: GM GLOBAL TECHNOLOGY OPERATIONS LLC, Detroit, MI (US)

(72) Inventors: Sai Vishnu Aluru, Commerce Twp., MI (US); Noor Abdelmaksoud, Madison Heights, MI (US)

(73) Assignee: GM GLOBAL TECHNOLOGY OPERATIONS LLC, Detroit, MI (US)

(21) Appl. No.: 17/652,969

(22) Filed: Mar. 1, 2022

(51) Int. Cl. G06T 7/77; G06T 7/35; G01S 17/89; G06T 7/11; G06V 20/58; G06V 10/82; G06V 10/25; G06V 10/46; B60W 60/00; B60W 30/09

(52) U.S. Cl. CPC G06T 7/77; G06T 7/35; G01S 17/89; G06T 7/11; G06V 20/58; G06V 10/82; G06V 10/25; G06V 10/476; B60W 60/001; B60W 30/09; G06T 2207/10048; G06T 2207/30252; G06T 2207/20084; G06T 2207/10028; B60W 2420/52; B60W 2554/80; B60W 2756/10

(57) ABSTRACT

A method in a vehicle is disclosed. The method includes: detecting an object in image data; defining a bounding box that surrounds the object; matching the object to data points in a point cloud from a LiDAR system; determining three-dimensional (3-D) position values from the data points for pixels in the image data; applying statistical operations to the 3-D position values; determining from the statistical operations a nature (real or imitation) of the object; determining a size for the object based on the 3-D position values; determine a shape for the object based on the 3-D position values; recognizing a category for the object using object recognition techniques based on the determined size and shape; and notifying a vehicle motion control system of the size, shape, and category of the object when the nature of the object is real to allow for appropriate driving actions in the vehicle.

### INTRODUCTION

The technical field generally relates to object detection and recognition, and more particularly relates to systems and methods in a vehicle for distinguishing real objects from imitations of real objects.

Vehicle perception systems have been introduced into vehicles to allow a vehicle to sense its environment and in some cases to allow the vehicle to navigate autonomously or semi-autonomously. Sensing devices that may be employed in vehicle perception systems include radar, LiDAR, image sensors, and others.

While recent years have seen significant advancements in vehicle perception systems, such systems might still be improved in a number of respects. Imaging systems, particularly those used in automotive applications, have difficulties distinguishing between real objects and imitations of real objects, such as signs, due to lack of depth perception. Imaging systems alone may be unable to resolve this ambiguity.

Accordingly, it is desirable to provide improved systems and methods for distinguishing real objects from imitations of real objects detected using imaging systems. Furthermore, other desirable features and characteristics of the present invention will become apparent from the subsequent detailed description and the appended claims, taken in conjunction with the accompanying drawings and the foregoing technical field and background.

The information disclosed in this introduction is only for enhancement of understanding of the background of the present disclosure and therefore it may contain information that does not form the prior art that is already known in this country to a person of ordinary skill in the art.

### SUMMARY

Disclosed herein are vehicle methods and systems and related control logic for vehicle systems, methods for making and methods for operating such systems, and motor vehicles equipped with onboard control systems. By way of example, and not limitation, there are presented various embodiments that differentiate between real objects and imitation objects captured by vehicle imaging systems, and a method for differentiating between real objects and imitation objects captured by vehicle imaging systems.

In one embodiment, a vehicle having an autonomous driving feature is disclosed. The vehicle includes a vehicle motion control system configured to provide the autonomous driving feature during vehicle driving operations, an imaging system configured to capture image data of vehicle surroundings during the vehicle driving operations, a LiDAR system configured to capture LiDAR data of the vehicle surroundings and generate a point cloud during the vehicle driving operations, and an object distinguishing system. The object distinguishing system includes a controller configured during the vehicle driving operations to: detect an object in the image data from the imaging system; define a bounding box that surrounds the object in the image data; match the object to data points in the point cloud from the LiDAR system; determine three-dimensional (3-D) position values from the data points for pixels in the image data that are within the bounding box; apply statistical operations to the 3-D position values; determine from the statistical operations a nature of the object, wherein the nature of the object is either real or imitation; determine a size for the object based on the 3-D position values; determine a shape for the object based on the 3-D position values; recognize a category for the object using object recognition techniques based on the determined size and shape; and notify the autonomous driving module of the size, shape, and category of the object when the nature of the object is real. The vehicle motion control system may cause the vehicle to take appropriate driving actions in view of the nature, size, shape, and category of the object.

In some embodiments, the statistical operations include statistical mean, statistical standard deviation, statistical z-score analysis, or density distribution operations.

In some embodiments, the controller is further configured to receive calibratable offsets and apply the calibratable offsets to set the bounding box.

In some embodiments, the controller is further configured to perform ground truth calibration and alignment for the field of view.

In some embodiments, the object recognition operations are performed using a trained neural network.

In some embodiments, the controller is configured to communicate the size, shape, and type of the object to a cloud-based server for transmission to other vehicles.

In some embodiments, the vehicle is further configured to receive the size, shape, and type of the object from a cloud-based server for use by the vehicle motion control system.

In some embodiments, the imaging system includes an infrared imaging system.

In one embodiment, a controller in a vehicle having an autonomous driving feature is disclosed. The controller is configured to: detect an object in image data from an imaging system in the vehicle configured to capture image data of vehicle surroundings during vehicle driving operations; define a bounding box that surrounds the object in the image data; match the object to data points in a point cloud from a LiDAR system in the vehicle that is configured to capture LiDAR data of the vehicle surroundings and generate a point cloud during the vehicle driving operations; determine three-dimensional (3-D) position values from the data points for pixels in the image data that are within the bounding box; apply statistical operations to the 3-D position values; determine from the statistical operations a nature of the object, wherein the nature of the object is either real or imitation; determine a size for the object based on the 3-D position values; determine a shape for the object based on the 3-D position values; recognize a category for the object using object recognition techniques based on the determined size and shape; and notify a vehicle motion control system that is configured to provide the autonomous driving feature during vehicle driving operations of the size, shape, and category of the object when the nature of the object is real. The vehicle motion control system may cause the vehicle to take appropriate driving actions in view of the nature, size, shape, and category of the object.

In some embodiments, the statistical operations includes a statistical mean, statistical standard deviation, statistical z-score analysis, or density distribution operations.

In some embodiments, the controller is further configured to receive calibratable offsets and apply the calibratable offsets to set the bounding box.

In some embodiments, the controller is further configured to perform ground truth calibration and alignment for the field of view.

In some embodiments, the object recognition operations are performed using a trained neural network.

In some embodiments, the controller is further configured to communicate the size, shape, and type of the object to a cloud-based server for transmission to other vehicles.

In one embodiment, a method in a vehicle having an autonomous driving feature is disclosed. The method includes: detecting an object in image data from an imaging system in the vehicle configured to capture image data of vehicle surroundings during vehicle driving operations; defining a bounding box that surrounds the object in the image data; matching the object to data points in a point cloud from a LiDAR system in the vehicle that is configured to capture LiDAR data of the vehicle surroundings and generate a point cloud during the vehicle driving operations; determining three-dimensional (3-D) position values from the data points for pixels in the image data that are within the bounding box; applying statistical operations to the 3-D position values; determining from the statistical operations a nature of the object, wherein the nature of the object is either real or imitation; determining a size for the object based on the 3-D position values; determine a shape for the object based on the 3-D position values; recognizing a category for the object using object recognition techniques based on the determined size and shape; and notifying a vehicle motion control system that is configured to provide the autonomous driving feature during vehicle driving operations of the size, shape, and category of the object when the nature of the object is real. The vehicle motion control system may cause the vehicle to take appropriate driving actions in view of the nature, size, shape, and category of the object.

In some embodiments, applying statistical operations includes applying statistical mean, statistical standard deviation, statistical z-score analysis, or density distribution operations.

In some embodiments, the method further includes receiving calibratable offsets and applying the calibratable offsets to set the bounding box.

In some embodiments, the method further includes performing ground truth calibration and alignment operations for the field of view.

In some embodiments, recognizing a category for the object using object recognition techniques includes recognizing a category for the object using a trained neural network.

In some embodiments, the method further includes communicating the size, shape, and type of the object to a cloud-based server for transmission to other vehicles.

In another embodiment, disclosed is a non-transitory computer readable media encoded with programming instructions configurable to cause a controller in a vehicle having an autonomous driving feature to perform a method. The method includes: detecting an object in image data from an imaging system in the vehicle configured to capture image data of vehicle surroundings during vehicle driving operations; defining a bounding box that surrounds the object in the image data; matching the object to data points in a point cloud from a LiDAR system in the vehicle that is configured to capture LiDAR data of the vehicle surroundings and generate a point cloud during the vehicle driving operations; determining three-dimensional (3-D) position values from the data points for pixels in the image data that are within the bounding box; applying statistical operations to the 3-D position values; determining from the statistical operations a nature of the object, wherein the nature of the object is either real or imitation; determining a size for the object based on the 3-D position values; determine a shape for the object based on the 3-D position values; recognizing a category for the object using object recognition techniques based on the determined size and shape; and notifying a vehicle motion control system that is configured to provide the autonomous driving feature during vehicle driving operations of the size, shape, and category of the object when the nature of the object is real. The vehicle motion control system may cause the vehicle to take appropriate driving actions in view of the nature, size, shape, and category of the object.

### BRIEF DESCRIPTION OF THE DRAWINGS

The exemplary embodiments will hereinafter be described in conjunction with the following drawing figures, wherein like numerals denote like elements, and wherein:

FIG. 1 is a block diagram depicting an example vehicle that includes an object distinguishing system, in accordance with an embodiment;

FIG. 2 is a depicts an example image from the example vehicle while traveling in its operating environment, in accordance with an embodiment;

FIG. 3 is a block diagram depicting a more detailed view of an example object distinguishing system, in accordance with an embodiment; and

FIG. 4 is a process flow chart depicting an example process in a vehicle that includes an example object distinguishing system, in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, LiDAR, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Autonomous and semi-autonomous vehicles are capable of sensing their environment and navigating based on the sensed environment. Such vehicles sense their environment using multiple types of sensing devices such as optical cameras, radar, LiDAR, other image sensors, and the like. Sensing technologies, however, have their weaknesses. The subject matter described herein discloses apparatus, systems, techniques, and articles for overcoming those weaknesses through fusing the data from different sensing technology types so that the strengths of each sensing technology type can be realized.

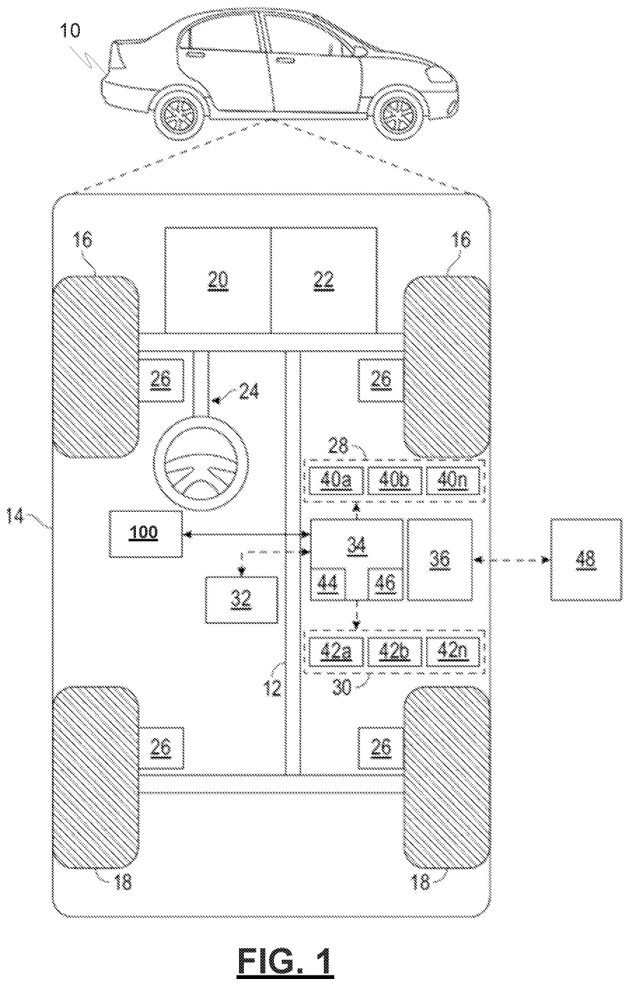

FIG. 1 depicts an example vehicle 10 that includes an object distinguishing system 100. As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 may be an autonomous vehicle or a semi-autonomous vehicle. An autonomous vehicle is, for example, a vehicle that is automatically controlled to carry passengers from one location to another. A semi-autonomous vehicle is, for example, a vehicle that has various autonomous driving features used when transporting passengers. Autonomous driving features include, but are not limited to, features such as cruise control, parking assist, lane keep assist, lane change assist, automated driving (level 3, level 4, level 5), and others.

The vehicle 10 is depicted in the illustrated embodiment as a passenger car, but other vehicle types, including trucks, sport utility vehicles (SUVs), recreational vehicles (RVs), etc., may also be used. The vehicle 10 may be capable of being driven manually, autonomously and/or semi-autonomously.

The vehicle 10 further includes a propulsion system 20, a transmission system 22 to transmit power from the propulsion system 20 to vehicle wheels 16-18, a steering system 24 to influence the position of the vehicle wheels 16-18, a brake system 26 to provide braking torque to the vehicle wheels 16-18, a sensor system 28, an actuator system 30, at least one data storage device 32, at least one controller 34, and a communication system 36 that is configured to wirelessly communicate information to and from other entities 48.

The sensor system 28 includes one or more sensing devices 40a-40n that sense observable conditions of the exterior environment and/or the interior environment of the vehicle 10 and generate sensor data relating thereto. The sensing devices 40a-40n can include but are not limited to, radars (e.g., long-range, medium-range-short range), LiDARs, global positioning systems, optical cameras (e.g., forward facing, 360-degree, rear-facing, side-facing, stereo, etc.), thermal (e.g., infrared) cameras, ultrasonic sensors, inertial measurement units, Ultra-Wideband sensors, odometry sensors (e.g., encoders) and/or other sensors that might be utilized in connection with systems and methods in accordance with the present subject matter. The actuator system 30 includes one or more actuator devices 42a-42n that control one or more vehicle features such as, but not limited to, the propulsion system 20, the transmission system 22, the steering system 24, and the brake system 26.

The data storage device 32 stores data for use in automatically controlling the vehicle 10. The data storage device 32 may be part of the controller 34, separate from the controller 34, or part of the controller 34 and part of a separate system. The controller 34 includes at least one processor 44 and a computer-readable storage device or media 46. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10. In various embodiments, the controller 34 implements machine learning techniques to assist the functionality of the controller 34, such as feature detection/classification, obstruction mitigation, route traversal, mapping, sensor integration, ground-truth determination, and the like.

The processor 44 can be any custom made or commercially available processor, a central processing unit (CPU), a graphics processing unit (GPU), an auxiliary processor among several processors associated with the controller 34, a semiconductor-based microprocessor (in the form of a microchip or chipset), a macro processor, any combination thereof, or generally any device for executing instructions. The computer-readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of several known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34. In various embodiments, controller 34 is configured to implement the object distinguishing system 100 as discussed in detail below.

The programming instructions may include one or more separate programs, each of which comprises an ordered listing of executable instructions for implementing logical functions. The one or more instructions of the controller 34, when executed by the processor 44, may configure the vehicle 10 to implement the object distinguishing system 100.

The object distinguishing system 100 includes any number sub-modules embedded within the controller 34, which may be combined and/or further partitioned to similarly implement systems and methods described herein. Additionally, inputs to the object distinguishing system 100 may be received from the sensor system 28, received from other control modules (not shown) associated with the vehicle 10, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

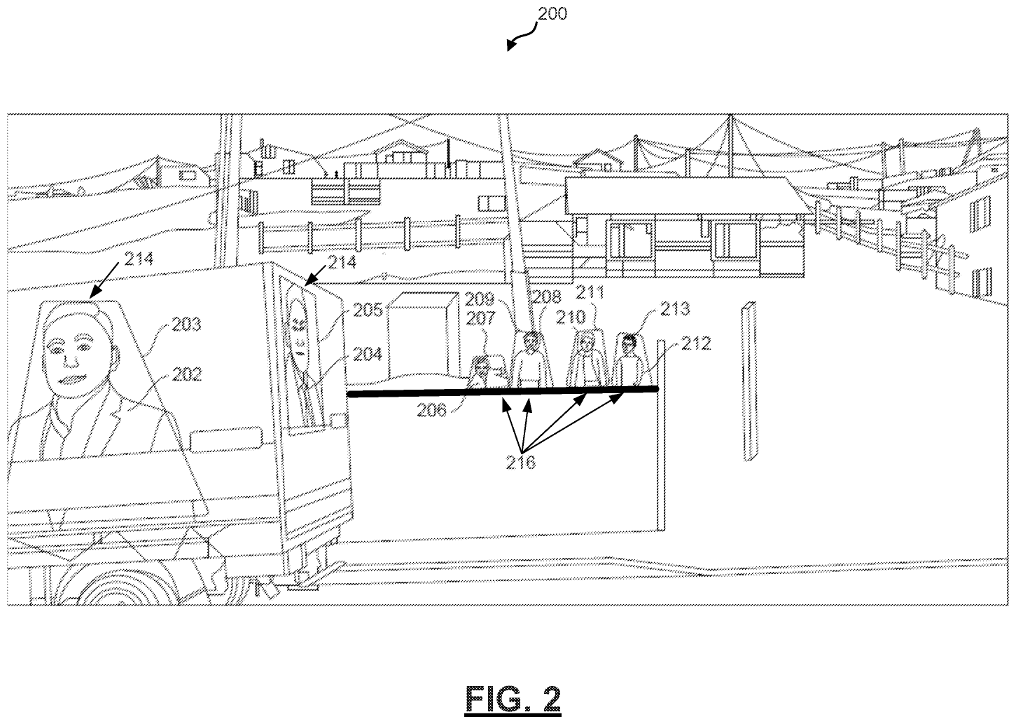

FIG. 2 depicts an example image 200 from the example vehicle 10 while traveling in its operating environment. The example image 200, includes six objects (202, 204, 206, 208, 210, 212) with six bounding boxes (203, 205, 207, 209, 211, 213) around the six objects. The six objects (202, 204, 206, 208, 210, 212) in the image data of example image 200 resemble a person that a conventional object recognition system on a vehicle that relies solely on the image data in the image 200 for object classification may classify each of the six objects (202, 204, 206, 208, 210, 212) as a person. A conventional object recognition system may misclassify objects 202 and 204 as real people causing a vehicle motion control system (e.g., an electronic control unit (ECU) and embedded software that control a personal autonomous automobile, shared autonomous automobile, or automobile with automated driving features) to take an unnecessary or improper action, such as unnecessary braking, steering, lane maneuvers, and increase or decrease in acceleration.

The example object distinguishing system 100 is, however, configured to identify objects 202 and 204 as pictures 214 of people (e.g., imitations) and objects 206, 208, 210, and 212 as real persons 216. The example object distinguishing system 100 is configured by programming instructions to distinguish the objects (202, 204, 206, 208, 210, 212) in the example image 200 as real or imitation objects.

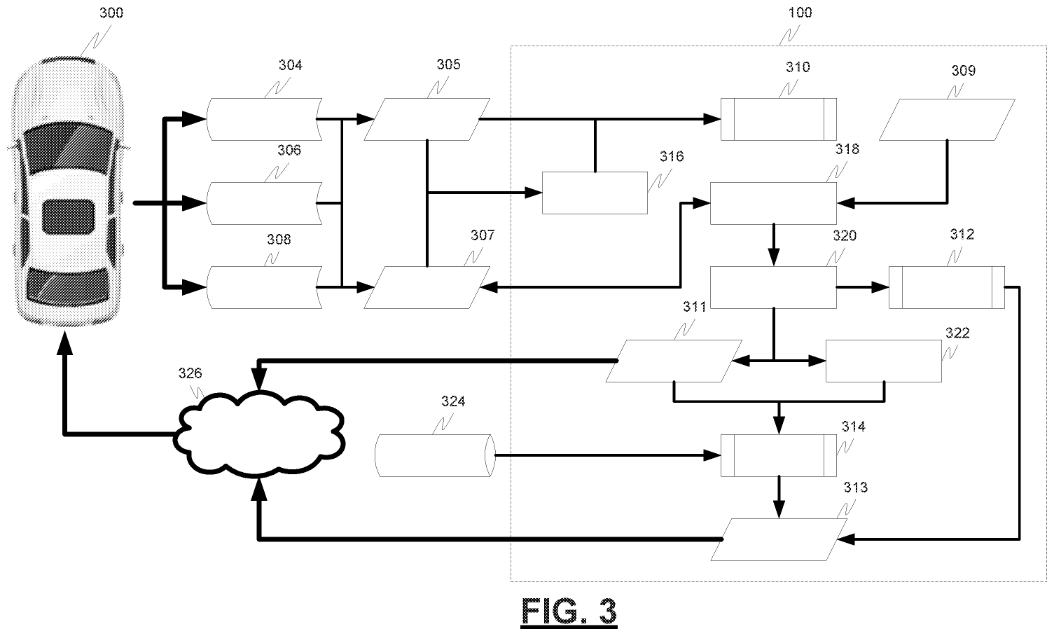

FIG. 3 is a block diagram depicting a more detailed view of an example object distinguishing system 100. The example object distinguishing system 100 is depicted in an example operating environment with a vehicle 300 that includes an imaging system 304, an infrared system 306, and a LiDAR system 308. The example imaging system 304 includes technology for capturing image data, such as a camera, radar, or other technology, of vehicle surroundings and to generate an image containing pixels therefrom during vehicle driving operations. The example infrared system 306 also includes technology for capturing image data of vehicle surroundings and to generate an image containing pixels therefrom during vehicle driving operations. The example LiDAR system 308 includes LiDAR technology for capturing LiDAR data of vehicle surroundings and to generate a point cloud during vehicle driving operations

The example object distinguishing system 100 includes an object detection module 310, a statistical module 312, and an object recognition module 314. The example object distinguishing system 100 is configured to use the object detection module 310 to detect objects (e.g., object 202, 204, 206, 208, 210, 212) in image data 305 from a vehicle imaging system (e.g., imaging system 304 and/or infrared system 306). The example object distinguishing system 100 may be configured to apply the object detection module 310 to detect certain types of objects, such as people, animals, trees, road signs, garbage cans, lane lines, instead of all objects, or to apply the object detection module 310 to detect and classify broader classes of objects.

The example object distinguishing system 100 performs ground truth calibration and alignment operations on the image data 305 within a particular field of view (FOV) via a ground truth calibration and alignment module 316 prior to performing object detection using the object detection module 310. Ground truth calibration and alignment operations allow the image data 305 to be related to real features and materials on the ground. In this example, the ground truth calibration and alignment operations involves comparing certain pixels in the image data 305 to what is there in reality (at the present time) in order to verify the contents of the pixels on the image data 305. The ground truth calibration and alignment operations also involve matching the pixels with X and Y position coordinates (e.g., GPS coordinates). The example ground truth calibration and alignment module 316 is configured to perform ground truth calibration and alignment operations for the FOV of the image using sensor data from various vehicle sensors.

The bounding box detection module 318 of example object distinguishing system 100 is configured to define bounding boxes (e.g., bounding boxes 203, 205, 207, 209, 211, 213) around detected objects in the image data 305. The size of the bounding boxes may be determined based on predetermined calibratable offsets 309 (e.g., a certain number of pixels beyond a recognized edge on a recognized object) or fixed offsets stored in a datastore. The calibratable offsets 309 may change based on different factors. For example, the set of offsets used may be determined by the example bounding box detection module 318 based on various factors such as the time of day (e.g., daylight or darkness), weather conditions (e.g., clear, cloudy, rain, snow), traffic patterns (e.g., heavy traffic, light traffic), travel path (e.g., highway, city street), speed, LiDAR resolution, LiDAR probability of detection, LiDAR frame rate, LiDAR performance metrics, camera resolution, camera frame rate, camera field of view, camera pixel density, and others. The calibratable offsets 309 may be set at the factory, at an authorized repair facility, or in some cases by vehicle owner.

A coordinate matching module 320 is configured to match the detected objects (e.g., 202, 204, 206, 208, 210, 212) to data points in a point cloud 307 from a LiDAR system 308 in the vehicle 300. The image pixels for the detected objects, which were previously mapped to X and Y position coordinates via the example ground truth calibration and alignment module 316 during ground truth calibration and alignment operations, are matched with data points in the point cloud 307 which have X, Y, and Z position coordinates. This allows the image pixels to be mapped to X, Y, and Z position coordinates. The coordinate matching module 320, as a result, determines three-dimensional (3-D) position values for the image pixels in the image data 305 based on corresponding data points in the point cloud 307. By mapping X, Y, and Z position coordinates to the image pixels, a four dimensional (4-D) image, referred to herein as a 4-D DepPix is formed. The 4-D DepPix provides a view of the environment around a vehicle from overlapping sensor data via multiplexing individual sensor data (e.g., multiplexing overlapping image pixels and LiDAR point cloud data). For example, one pixel from a camera containing Color-R, Color-G, Color-B data (RGB data) can be fused with depth data from a point cloud.

The example object distinguishing system 100 applies a statistical module 312 to apply statistical operations to the 3-D position values (from the 4-D DepPix) to determine from the statistical operations the nature of the detected objects, that is, whether the objects are either real objects or imitation objects (e.g., a picture, reflection, photograph, painting, etc. of an object). The statistical operations are performed to determine if the object containing the pixels has sufficient depth to indicate that the object is real or, alternatively, to determine if the object is in one plane, which is indicative of the object being an imitation. The statistical operations may include statistical mean, statistical standard deviation, statistical z-score analysis, density distribution operations, or others. The statistical operations can allow for accurate differentiation between real physical objects and imitations of an object. As a result, the example object distinguishing system 100 can accurately differentiate between real physical objects and imitations of an object through fusing LiDAR points (e.g., point cloud data) of an object with image data from an imaging device such as a camera.

The example object distinguishing system 100 is configured to determine an object size 311 for each object based on the 3-D position values (from the 4-D DepPix) and applies a shape detection module 322 to identify the shape of detected objects. The example shape detection module 322 is configured to determine a shape for each detected object based on the 3-D position values (from the 4-D DepPix). The fusing of the LiDAR point cloud data with image pixels allows for improved 3D recognition of a real object's shape and size.

The object recognition module 314 is configured to recognize an object category for each object using object recognition techniques based on the object size 311 and object shape. In some examples, the object recognition module 314 applies decision rules such as Maximum Likelihood Classification, Parallelepiped Classification, and Minimum Distance Classification to perform object recognition operations. In some examples, the example object recognition module 314 applies a trained neural network 324 to perform object recognition operations. The fusing of the LiDAR point cloud data with image pixels allows for enhanced three-dimensional (3D) object recognition.

Based on the object category for an object determined by the object recognition module 314 and the statistical operations applied to the object pixels by the statistical module 312 to determine the nature of the object (e.g., real or an imitation), the example object distinguishing system 100 is configured to determine the object type 313 (e.g., a real person or a picture of a person). The example object distinguishing system 100 is further configured to send the object size 311 and object type 313 for each object to a vehicle motion control system for use in taking appropriate driving actions (e.g., braking, moving to a new lane, reducing acceleration, stopping, etc.) in view of the nature, size, shape, and category of the object(s).

The example object distinguishing system 100 may also send the object size 311 and object type 313 for detected objects to a cloud-based server 326 that receives object size 311 and object type 313 information from one or more vehicles that are equipped with an object distinguishing system 100. The cloud-based server 326 can then send the object size 311 and object type 313 information for detected objects to other vehicles for use by a vehicle motion control system in those vehicles to take appropriate driving actions in view of the nature, size, shape, and category of the object(s). The vehicle 300 may also receive object size and object type information from the cloud-based server 326 and use the received object size and object type information to take appropriate driving actions.

The example object distinguishing system 100 therefore fuses sensed data (image and point cloud data) together for greater environmental awareness.

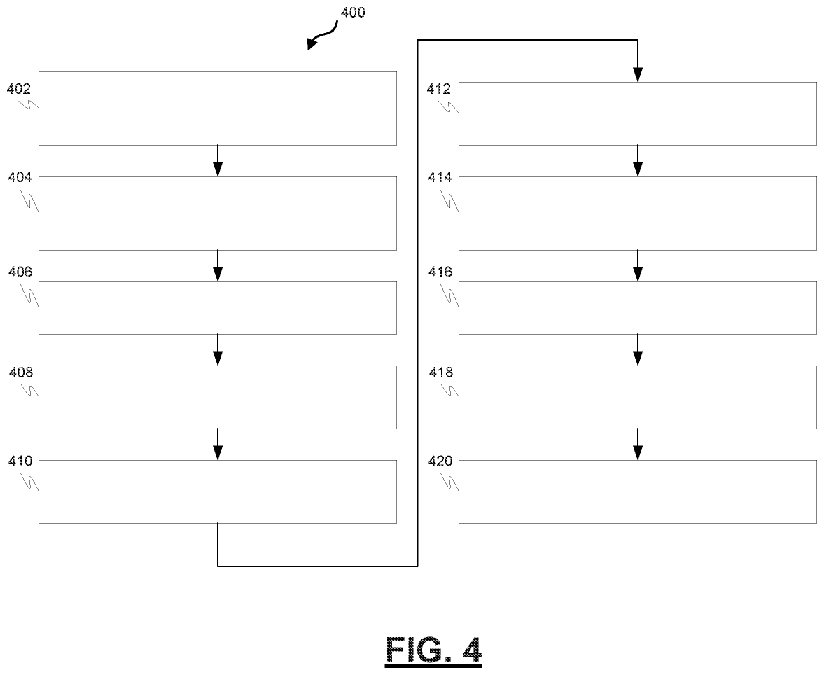

FIG. 4 is a process flow chart depicting an example process 400 that is implemented in a vehicle that includes the example object distinguishing system 100. The order of operation within the process 400 is not limited to the sequential execution as illustrated in the FIG. 4 but may be performed in one or more varying orders as applicable and in accordance with the present disclosure.

The example process 400 includes detecting an object in image data from an imaging system in the vehicle configured to capture image data of vehicle surroundings during vehicle driving operations (operation 402). As an example, the image data may include camera image data, infrared image data, radar image data, and/or some other type of image data. Ground truth calibration and alignment operations may be performed on the image data prior to performing object detection. The ground truth calibration and alignment operations may involve mapping certain pixels to X and Y position coordinates (e.g., GPS coordinates).

The example process 400 includes defining a bounding box that surrounds the object in the image data (operation 404). The size of the bounding box may be determined based on predetermined calibratable offsets or fixed offsets. The calibratable offsets may change based on different factors. For example, the set of offsets used may be determined based on various factors such as the time of day (e.g., daylight or darkness), weather conditions (e.g., clear, cloudy, rain, snow), traffic patterns (e.g., heavy traffic, light traffic), travel path (e.g., highway, city street), speed, LiDAR resolution, LiDAR probability of detection, LiDAR frame rate, LiDAR performance metrics, camera resolution, camera frame rate, camera field of view, camera pixel density, and others. The calibratable offsets may be set at the factory, at an authorized repair facility, or in some cases by a vehicle owner.

The example process 400 includes matching the object to data points in a point cloud from a LiDAR system in the vehicle (operation 406). The LiDAR system is configured to capture LiDAR data of the vehicle surroundings and generate a point cloud during the vehicle driving operations.

The example process 400 includes determining three-dimensional (3-D) position values for pixels in the image data that are within the bounding box (operation 408). The 3-D pixel values (e.g., X, Y, and Z coordinates from GPS) are determined by mapping pixels to corresponding data points in the point cloud. By mapping X, Y, and Z coordinates to the image pixels, a four dimensional (4-D) image, referred to herein as a 4-D DepPix can be formed.

The example process 400 includes applying statistical operations to the 3-D position values (e.g., from the 4-D DepPix) (operation 410). The statistical operations may include but are not limited to statistical mean, statistical standard deviation, statistical z-score analysis density distribution operations, or others.

The example process 400 includes determining from the statistical operations a nature of the object (operation 412). The nature of the object is either real or imitation (e.g., picture). The statistical operations are performed to determine if the object containing the pixels has sufficient depth to indicate that the object is real or, alternatively, to determine if the object is in one plane, which is indicative of the object being an imitation.

The example process 400 includes determining a size and a shape for the object based on the 3-D position values (e.g., from the 4-D DepPix) (operation 414) and recognizing a category (e.g., person, car, etc.) for the object using object recognition techniques based on the determined size and shape (operation 416). A trained neural network 324 may be used to perform object recognition operations to recognize the category for the object.

The example process 400 includes determining the type of object (e.g., a real person or a picture of a person) that was detected (operation 418). The object type is determined based on the object category for the object and the statistical operations applied to the object pixels to determine the nature of the object (e.g., real or an imitation).

The example process 400 includes notifying a vehicle motion control system of the object size and object type (operation 420). The vehicle motion control system may use the object size and object type information to take appropriate driving actions (e.g., braking, moving to a new lane, reducing acceleration, stopping, etc.).

The example process 400 may optionally include sending the object size and object type information to a cloud-based server (operation 420). The cloud-based server may optionally send the object size and object type information to other vehicles so that those vehicles can take appropriate driving actions in view of the object size and object type information.

The apparatus, systems, techniques, and articles provided herein disclose a vehicle that can distinguish whether an object in the vehicle's image stream is a real object or an imitation (e.g., picture). This can help increase confidence that the vehicle is accurately recognizing its surroundings and can help the vehicle gain more knowledge about its current operating scenario to improve vehicle navigation through its current operating environment.

The apparatus, systems, techniques, and articles provided herein disclose a method of generating a 4-D DepPix. The apparatus, systems, techniques, and articles provided herein disclose a method of accurate object recognition and precise size prediction from a 4-D DepPix. The apparatus, systems, techniques, and articles provided herein disclose a method of real object versus imitations of real object recognition from a 4-D DepPix. The apparatus, systems, techniques, and articles provided herein disclose a system that can accurately differentiate between real objects and pictures with confidence. The apparatus, systems, techniques, and articles provided herein disclose a system with enhanced object recognition capabilities through more precise and accurate calculation of object size. This can also increase the overall safety of autonomous applications.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A vehicle having an autonomous driving feature, the vehicle comprising:
a vehicle motion control system configured to provide the autonomous driving feature during vehicle driving operations;
an imaging system configured to capture image data of vehicle surroundings during the vehicle driving operations;
a LiDAR system configured to capture LiDAR data of the vehicle surroundings and generate a point cloud during the vehicle driving operations, and
an object distinguishing system, the object distinguishing system comprising a controller configured during the vehicle driving operations to:
detect an object in the image data from the imaging system;
define a bounding box that surrounds the object in the image data;
match the object to data points in the point cloud from the LiDAR system;
determine three-dimensional (3-D) position values from the data points for pixels in the image data that are within the bounding box;
apply statistical operations to the 3-D position values;
determine from the statistical operations a nature of the object, wherein the nature of the object is either real or imitation;
determine a size for the object based on the 3-D position values;
determine a shape for the object based on the 3-D position values;
recognize a category for the object using object recognition techniques based on the determined size and shape; and
notify the vehicle motion control system of the size, shape, and category of the object when the nature of the object is real;
wherein the vehicle motion control system is configured to cause the vehicle to take appropriate driving actions in view of the nature, size, shape, and category of the object.

2. The vehicle of claim 1, wherein the statistical operations comprises statistical mean, statistical standard deviation, statistical z-score analysis, or density distribution operations.

3. The vehicle of claim 1, wherein the controller is further configured to receive calibratable offsets and apply the calibratable offsets to set the bounding box.

4. The vehicle of claim 1, wherein the controller is further configured to perform ground truth calibration and alignment for a field of view.

5. The vehicle of claim 1, wherein the object recognition operations are performed using a trained neural network.

6. The vehicle of claim 1, wherein the controller is configured to communicate the size, shape, and type of the object to a cloud-based server for transmission to other vehicles.

7. The vehicle of claim 1, further configured to receive the size, shape, and type of the object from a cloud-based server for use by the vehicle motion control system.

8. The vehicle of claim 1, wherein the imaging system comprises an infrared imaging system.

9. A controller in a vehicle having an autonomous driving feature, the controller configured to:
detect an object in image data from an imaging system in the vehicle configured to capture image data of vehicle surroundings during vehicle driving operations;
define a bounding box that surrounds the object in the image data;
match the object to data points in a point cloud from a LiDAR system in the vehicle that is configured to capture LiDAR data of the vehicle surroundings and generate a point cloud during the vehicle driving operations;
determine three-dimensional (3-D) position values from the data points for pixels in the image data that are within the bounding box;
apply statistical operations to the 3-D position values;
determine from the statistical operations a nature of the object, wherein the nature of the object is either real or imitation;
determine a size for the object based on the 3-D position values;
determine a shape for the object based on the 3-D position values;
recognize a category for the object using object recognition techniques based on the determined size and shape; and
notify a vehicle motion control system that is configured to provide the autonomous driving feature during vehicle driving operations of the size, shape, and category of the object when the nature of the object is real;
wherein the vehicle motion control system is configured to cause the vehicle to take appropriate driving actions in view of the nature, size, shape, and category of the object.

10. The controller of claim 9, wherein the statistical operations comprises statistical mean, statistical standard deviation, statistical z-score analysis, or density distribution operations.

11. The controller of claim 9, further configured to receive calibratable offsets and apply the calibratable offsets to set the bounding box.

12. The controller of claim 9, further configured to perform ground truth calibration and alignment for a field of view.

13. The controller of claim 9, wherein the object recognition operations are performed using a trained neural network.

14. The controller of claim 9, further configured to communicate the size, shape, and type of the object to a cloud-based server for transmission to other vehicles.

15. A method in a vehicle having an autonomous driving feature, the method comprising:
detecting an object in image data from an imaging system in the vehicle configured to capture image data of vehicle surroundings during vehicle driving operations;
defining a bounding box that surrounds the object in the image data;
matching the object to data points in a point cloud from a LiDAR system in the vehicle that is configured to capture LiDAR data of the vehicle surroundings and generate a point cloud during the vehicle driving operations;
determining three-dimensional (3-D) position values from the data points for pixels in the image data that are within the bounding box;
applying statistical operations to the 3-D position values;
determining from the statistical operations a nature of the object, wherein the nature of the object is either real or imitation;
determining a size for the object based on the 3-D position values;
determine a shape for the object based on the 3-D position values;
recognizing a category for the object using object recognition techniques based on the determined size and shape; and
notifying a vehicle motion control system that is configured to provide the autonomous driving feature during vehicle driving operations of the size, shape, and category of the object when the nature of the object is real;
wherein the vehicle motion control system is configured to cause the vehicle to take appropriate driving actions in view of the nature, size, shape, and category of the object.

16. The method of claim 15, wherein applying statistical operations comprises applying statistical mean, statistical standard deviation, statistical z-score analysis, or density distribution operations.

17. The method of claim 15, further comprising receiving calibratable offsets and applying the calibratable offsets to set the bounding box.

18. The method of claim 15, further comprising performing ground truth calibration and alignment operations for a field of view.

19. The method of claim 15, wherein recognizing a category for the object using object recognition techniques comprises recognizing a category for the object using a trained neural network.

20. The method of claim 15, further comprising communicating the size, shape, and type of the object to a cloud-based server for transmission to other vehicles.
